(19) United States
(12) Patent Application Publication
(10) Pub. No.: US 2005/0088298 A1
(43) Pub. Date: Apr. 28, 2005

(54) Baby monitor

(76) Inventor: Chi Cheung Liu, Hong Kong (HK)

Correspondence Address: ALIX YALE & RISTAS LLP, 750 MAIN STREET, SUITE 1400, HARTFORD, CT, 06103, US

(21) Appl. No.: 10/683,053

(22) Filed: Oct. 10, 2003

(51) Int. Cl. G08B 1/08

(52) U.S. Cl. 340/539.15; 340/573.1

(57) ABSTRACT

A baby monitor includes a transmitter unit and receiving unit. The transmitting unit has a microphone and a transmitter for detecting and transmitting a baby sounds. The receiving units comprises a personal entertainment system, such as radio, a receiver for receiving the baby sound, an amplifier with speaker for outputting baby signal and/or sounds from the personal entertainment system, and a controller. The controller mutes sounds from the personal entertainment system when baby sounds are received.

### BACKGROUND TO THE INVENTION

1. Field of the Invention

The invention relates to baby monitors.

2. Background Information

Baby monitors that allow remote monitoring of a baby are well-known. The device typically includes a transmitter (baby) unit which is place in a room with a baby or infant who is either playing or sleeping, and a receiving (parent/guardian) unit which is located in another part of the house or building where the guardian is. The transmitting unit detects sound made by the baby and transmits this sound to the receiving unit where it is output via a speaker. The receiving unit may also have one or more visual indicators.

One problem is that the guardian monitoring the receiving unit might wish to listen to entertainment such as a TV or radio. This causes a problem as the guardian may not hear baby sounds from the receiving unit.

### SUMMARY OF THE INVENTION

It is an object of the present invention to provide a baby monitor which overcomes or ameliorates the above mentioned problem.

According to a first aspect of the invention there is provided a receiver for use in monitoring baby from a remote location comprising;
a radio receiver for receiving broadcast radio signals,
an amplifier with speaker for outputting received baby sounds and/or radio sounds, and
a controller for muting radio sounds when baby sounds are received.

According to a second aspect of the invention there is provided a baby monitor including:
a transmitter unit having a microphone and a transmitter for detecting and transmitting a baby sound, and
a receiving unit comprising:
   a receiver for receiving the baby sound,
   a personal entertainment system,
   an amplifier with speaker for outputting baby signal and/or sounds from the personal entertainment system, and
   a controller for muting sounds from the personal entertainment system when baby sounds are received.

Preferably, the personal entertainment system is a radio.

According to a third aspect of the invention there is provided a personal entertainment system for use in monitoring baby from a remote location comprising:
a receiver for receiving baby sounds,
an amplifier with speaker for outputting baby signal and/or sounds from a personal entertainment system, and
a controller for muting sounds from the personal entertainment system when baby sounds are received.

Further aspects of the invention will become apparent from the following description, which is given by way of example only.

### BRIEF DESCRIPTION OF THE DRAWINGS

An embodiment of the invention will now be described by way of example only and with reference to the accompanying drawing, in which:

FIG. 1 is a schematic of a transmitting unit for a baby monitor,

FIG. 2 is a schematic of a receiving unit of a baby monitor according to the invention.

### DESCRIPTION OF THE PREFERRED EMBODIMENT

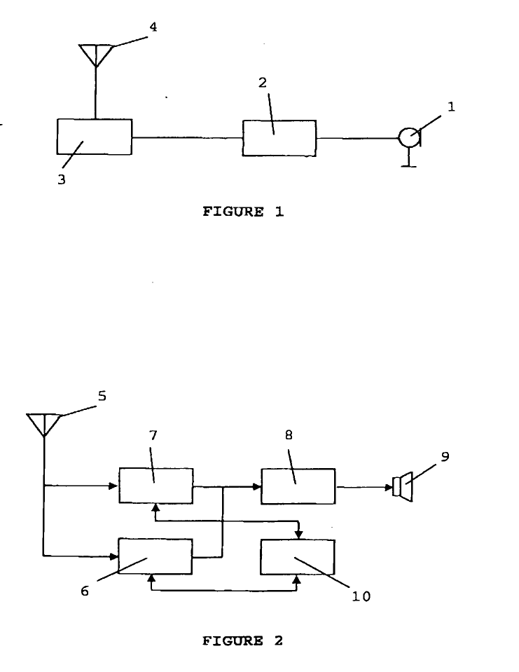

Referring to FIG. 1, a transmitting unit of a baby monitor includes a microphone 1, a microphone amplifier 2, a transmitter 3, and an antenna 4. The transmitting unit is located in a room with a baby that is to be monitored. The microphone 1 detects sounds made by the baby. The sounds are amplified by microphone amplifier 2 and transmitted to a receiving unit by transmitter 3 and antenna 4.

Referring FIG. 2, the receiving unit include an antenna 5 a baby signal receiver 6 a radio receiving unit 7 and audio amplifier 8 with speaker 9 and a muting control unit 10. The radio receiving unit is implemented in known manner and may include a tuner, volume control and frequency scanning function. The tuned radio signal is passed to amplifier 8 for output on speaker 9.

While the radio function is operating the baby signal receiver 6 is ‘listening’ for baby sounds from the transmitting unit. Muting control unit 10 is connected to baby sound receiver 6 and radio unit 7. If baby sounds are detected then muting controller 10 mutes the radio output so that the baby sounds can be output by audio amplifier 8 and speaker 9.

A receiving unit according to the invention allows the person monitoring the baby to listen to radio broadcast entertainment signals without fear that they will not hear baby sounds. If baby sounds occur the radio output is muted and the baby sounds are output from the speaker.

The receiving unit may also includes visual indicators such as LEDs or LCD displays to indicates that baby sounds have been received and the radio output is muted.

In the preferred embodiment the receiving unit includes a radio tuner. In alternative embodiments the receiving unit may comprise a TV and other personal entertainment system such as MP3 player, CD player, VCD player, DVD player, MD player, cassette tape player or the like. The muting control mutes the sound output from the TV or personal entertainment system when Baby sounds are detected by the baby sound receiver.

Where in the foregoing description reference has been made to integers or elements have known equivalents then such are included as if individually set forth herein.

Embodiments of the invention having been described, however it is understood that variations, improvements or modifications can take place without departure from the spirit of the invention or scope of the appended claims.

1. A receiver for use in monitoring a baby from a remote location comprising:
a radio receiver for receiving broadcast radio signals,
an amplifier with speaker for outputting received baby sounds and/or radio sounds, and
a controller for muting radio sounds when baby sounds are received.

2. A baby monitor including:
a transmitter unit having a microphone and a transmitter for detecting and transmitting a baby sound, and
a receiving unit comprising:
is a receiver for receiving the baby sound,
a personal entertainment system,
an amplifier with speaker for outputting baby signal and/or sounds from the personal entertainment system, and
a controller for muting sounds from the personal entertainment system when baby sounds are received.

3. The baby monitor of claim 1 wherein the personal entertainment system is a radio.

4. A personal entertainment system for use in monitoring baby from a remote location comprising:
a receiver for receiving baby sounds,
an amplifier with speaker for outputting baby signal and/or sounds from a personal entertainment system, and
a controller for muting sounds from the personal entertainment system when baby sounds are received.
